(19) United States
(12) Patent Application Publication
(10) Pub. No.: US 2025/0102712 A1
(43) Pub. Date: Mar. 27, 2025

(54) DEVICE FOR ENHANCING LIGHT TRANSMITTANCE OF GLASS

(71) Applicant: TUDATONG (SUZHOU) CO., LTD., SUZHOU (CN)

(72) Inventors: Xinghua Pu, SUZHOU (CN); Junwei Bao, SUZHOU (CN)

(73) Assignee: TUDATONG (SUZHOU) CO., LTD., SUZHOU (CN)

(21) Appl. No.: 18/832,909

(22) PCT Filed: Jan. 19, 2023
(86) PCT No.: PCT/IB2023/050445

§ 371 Date: Jul. 24, 2024

(30) Foreign Application Priority Data
Jan. 25, 2022 (CN) 202210086302.X

(51) Int. Cl. G02B 5/04; G02B 1/11

(52) U.S. Cl. CPC G02B 5/04; G02B 1/11

(57) ABSTRACT

The present invention discloses a device for enhancing the light transmittance of glass. The device comprises a lidar arranged inside a vehicle, and a wedge-shaped prism configured to be tightly fitted to the inside surface of the vehicle glass. The thicker end of the wedge-shaped prism is arranged at the lower side of the inside surface of the vehicle glass, and the emergent light of the lidar is emitted and returned through the wedge-shaped prism and the vehicle glass. According to the present invention, the incident angle of the laser on the glass surface is reduced by arranging the wedge-shaped prism on the inside surface of the vehicle glass, thereby enhancing the transmittance of the glass.

### CROSS-REFERENCE TO RELATED APPLICATIONS

This application claims priority to Chinese Patent Application No. 202210086302.X, filed Jan. 25, 2022, entitled “A DEVICE FOR ENHANCING THE LIGHT TRANSMITTANCE OF GLASS,” the content of which is hereby incorporated by reference in its entirety.

### TECHNICAL FIELD

Embodiments of the present invention relate to the technical field of vehicle-mounted lidar, and in particular to a device for enhancing the light transmittance of glass.

### BACKGROUND

Vehicle-mounted lidar may be mounted outside a vehicle, for example, on the roof or on the outer side of a vehicle, or may be mounted inside a vehicle. When a vehicle-mounted lidar is mounted inside a vehicle, the laser beam will pass through the vehicle glass twice as it is emitted and received. Due to the reflection and absorption by the vehicle glass, the laser intensity will be reduced, thereby affecting the main performance of the lidar such as detection distance and signal quality. The magnitude of the decrease in laser intensity is determined by the light transmittance of the vehicle glass which decreases as the incident angle increases. The receiving laser returns in reverse along the same path with the same principle of light transmittance.

An optical transmission path of the vehicle-mounted lidar in the prior art is shown in FIG. 1. Since the angle between the front glass of the vehicle and the horizontal plane is usually much less than 90%, the incident angle of the laser is increased, thereby causing the light transmittance to decrease.

### SUMMARY

The present invention provides a device for enhancing the light transmittance of glass to reduce the incident angle of laser and improve the light transmittance of vehicle glass.

Embodiments of the present invention provide a device for enhancing the light transmittance of glass, which comprises a lidar provided inside a vehicle, and a wedge-shaped prism configured to be tightly fitted to the inside surface of the vehicle glass, wherein the thicker end of the wedge-shaped prism is arranged at the lower side of the inside surface of the vehicle glass, and the emergent light of the lidar is emitted and returned through the wedge-shaped prism and the vehicle glass.

Optionally, the wedge-shaped prism has the same or similar refractive index as the vehicle glass.

Optionally, if the vehicle glass and the wedge-shaped prism have different refractive indices, a transition layer is provided therebetween to improve the matching between the refractive indices of the wedge-shaped prism and the vehicle glass.

Optionally, the wedge-shaped prism is arranged on the inside surface of the vehicle glass by means of gluing.

Optionally, the included angle between the wedge-shaped prism and the upper side of the inside surface of the vehicle glass is greater than zero and lower than 30 degrees.

Optionally, the surface of the wedge-shaped prism is coated with an antireflection film.

According to the present invention, the incident angle of the laser on the glass surface is reduced by arranging the wedge-shaped prism on the inside surface of the vehicle glass, thereby enhancing the transmittance of the glass. The refractive index of the wedge-shaped prism is close to that of the vehicle glass so that secondary reflection and refraction interface can be avoided, and the loss of light energy can be reduced. By adjusting the wedge-shaped prism, the incident angle is away from the Brewster angle, thus avoiding energy loss caused by polarization of the emergent light.

### BRIEF DESCRIPTION OF THE DRAWINGS

FIG. 1 is a schematic diagram of the operation of an in-vehicle lidar in the prior art; and

FIG. 2 is a schematic structural diagram of a device for enhancing the light transmittance of glass according to an embodiment of the present invention.

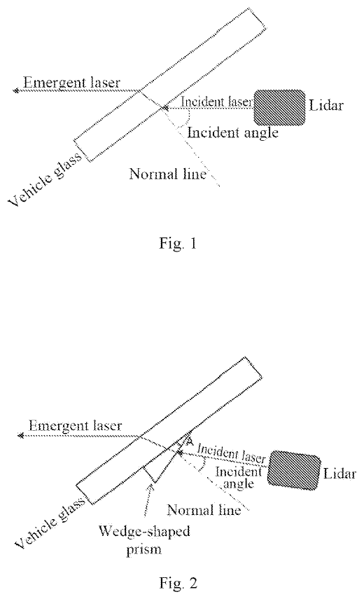

### DETAILED DESCRIPTION OF EMBODIMENTS

The present invention is described in further detail below with reference to the drawings and embodiments. It can be understood that specific embodiments described herein are merely used to explain the present invention, rather than limiting the present invention. It should be noted that, for ease of description, only some but not all structures related to the present invention are shown in the drawings.

### EMBODIMENTS

FIG. 2 is a schematic structural diagram of a device for enhancing the light transmittance of glass according to an embodiment of the present invention. The device includes a lidar arranged inside a vehicle, and a wedge-shaped prism configured to be tightly fitted to the inside surface of the vehicle glass, wherein the thicker end of the wedge-shaped prism is arranged at the lower side of the inside surface of the vehicle glass, and the emergent light of the lidar is emitted and returned through the wedge-shaped prism and the vehicle glass.

In this embodiment, after the wedge-shaped prism is arranged, the horizontal position of the lidar is adjusted according to the angle of the wedge-shaped prism so that the emergent light of the lidar is slightly lifted in the vertical direction and the emergent light angle and the vertical scanning angle remain within a constant range.

Preferably, the wedge-shaped prism may be arranged on the inside surface of the vehicle glass by means of gluing, and the curvature of the side surface of the wedge-shaped prism that is tightly fitted to the vehicle glass is variable, thereby realizing a tight fit between the wedge-shaped prism and the vehicle. Further, the other side surface of the wedge-shaped prism is of a variable shape, and the shape of the other surface of the wedge-shaped prism is designed by calculating the optimal incident angle at different positions of the vehicle glass to achieve optimum transmission performance over the entire laser scanning range.

In this embodiment, the wedge angle A of the wedge-shaped prism is variable, which is substantially between zero and 30 degrees, to meet the requirements of different transmittances and make the incident angle away from the Brewster angle thereby avoiding energy loss caused by polarization of the emergent light.

Preferably, the wedge-shaped prism has the same or similar refractive index as the vehicle glass to avoid secondary reflection and refraction.

Alternatively, when the refractive indices of the wedge-shaped prism and the vehicle glass are different, a transition layer is provided therebetween to improve the matching between the refractive indices.

Further, the surface of the wedge-shaped prism may be coated with an antireflection film to increase the transmittance.

In this embodiment, the emitted laser is directed into the glass through the wedge-shaped prism, and the incident angle of the laser is reduced compared to the existing solutions due to the combined effect of the angular lift of the wedge-shaped prism and the vertical lift of the emergent light, resulting in a higher transmittance. After the emergent laser passes through the glass, the reflected signal light follows the opposite optical path through the glass and the wedge-shaped prism once more, and the transmittance of the reflected light is also higher than that of the existing solutions. After passing through the glass with higher transmittance twice, the overall transmittance of the laser is higher than that of the existing solutions, thereby improving the detection distance and the signal quality of the lidar.

It is to be noted that only preferred embodiments of the present invention and the technical principles employed have been described above. Those skilled in the art would understand that the present invention is not limited to the specific embodiments described herein, and various obvious changes, rearrangements and substitutions can be made by those skilled in the art without departing from the scope of protection of the present invention. Therefore, although the present invention has been described in detail through the above embodiments, the present invention is not limited to the above embodiments and could also include more equivalent embodiments without departing from the concept of the present invention and the scope of the present invention is defined by the scope of the appended claims.

What is claimed is:

1. A device for enhancing the light transmittance of glass, comprising:
a lidar arranged inside a vehicle, and
a wedge-shaped prism configured to be tightly fitted to the inside surface of the vehicle glass, wherein
the thicker end of the wedge-shaped prism is arranged at the lower side of the inside surface of the vehicle glass, and the emergent light of the lidar is emitted and returned through the wedge-shaped prism and the vehicle glass.

2. The device according to claim 1, wherein the wedge-shaped prism has the same or similar refractive index as the vehicle glass.

3. The device according to claim 2, wherein if the refractive indices of the vehicle glass and the wedge-shaped prism are different, a transition layer is provided therebetween to improve the matching between the refractive indices of the wedge-shaped prism and the vehicle glass.

4. The device according to claim 1, wherein the wedge-shaped prism is arranged on the inside surface of the vehicle glass by means of gluing.

5. The device according to claim 1, wherein the included angle between the wedge-shaped prism and the upper side of the inside surface of the vehicle glass is greater than zero and lower than 30 degrees.

6. The device according to claim 1, wherein the surface of the wedge-shaped prism is coated with an antireflection film.
